(19) United States
(12) Patent Application Publication
(10) Pub. No.: US 2013/0097224 A1
(43) Pub. Date: Apr. 18, 2013

(54) Client Defined Server Applications

(71) Applicant: Lars Reinertsen, London (GB)

(72) Inventor: Lars Reinertsen, London (GB)

(21) Appl. No.: 13/275,226

(22) Filed: Oct. 17, 2011

(51) Int. Cl. G06F 15/16

(52) U.S. Cl. 709/203

(57) ABSTRACT

A method of client to client communication, by: (a) providing first and second clients which both have the same application running thereon, wherein the application defines structure and content for an XML schema; (b) having the first client send XML data to a server; (c) having the second client send an XML search to the server; and (d) having the server send XML search results to the second client, wherein the XML search results comprise the XML data sent to the server by the first client.

### TECHNICAL FIELD

The present application relates to client-server computer systems.

### BACKGROUND OF THE INVENTION

Existing three-tier architecture is used for standard client-server applications. Specifically, this architecture involves a client, a server, and a database. The client is typically a browser, the server is the location where an application resides, and the necessary data to run the system is stored within the database. In operation, a plurality of different clients (e.g.: different individual users operating Internet browsers) all access the same application which is hosted on a central server. This is like a wheel with hub and spokes, where the hub is the application and the spokes are the clients, and the spokes connect only with the hub. In these systems, the browser is “thin” meaning that the browser has minimal execution of logic. This enables it to interact easily with multiple applications. The more code that is executed on the client/browser, the “thicker” it becomes. This makes it less flexible to operate with other applications. The information resides on the server, as does the application logic and thin clients interact with it; and through it the clients interact with one another. Even phone applications and social networking operate under this system, and are therefore essentially hub-and-spoke systems.

A limitation of these existing systems is that, regardless of how the logic is distributed between the client and server, the application remains tied to the server. (i.e.: where the logic is installed and executed at the server). Without the server, the application is non-functional or seriously impaired. A further disadvantage of this system is that the users have no choice in communication protocol and syntax. Instead, the server application defines the protocol and syntax, and the users must comply with it. Moreover, applications designers are similarly constrained since the server application defines what can be communicated and how.

It is therefore desirable to create a system that has the flexibility to permit designers and users to define their own communication standards. In addition, different on-line communities exchange information in a way that can have different vocabulary and meaning. Therefore, it would therefore be desirable to create a platform that can accommodate such flexibility.

### SUMMARY OF THE INVENTION

In accordance with the present invention, a computer application is tied to the client and not to the server. The server has generic capability. Therefore, an advantage of the present system is that the application can be executed on almost any server. In addition, the server preferably places no restrictions on what the clients can send. Instead, the client defines the communication syntax and content.

In accordance with the present invention, the information syntax and content are both defined in terms of XML schema. This XML schema used depends upon the particular clients that communicate with one another. The present invention thus provides client-to-server-to-client communication with a shared XML vocabulary. As such, the clients themselves agree on what the structure and content of the communication should be. Thus, the application being run (by the client) defines both the information to send and how to interpret it.

Similar to a bulletin board, messages (XML documents) are posted to a central location and users can search and retrieve them as desired. Any server running the software can act as the “bulletin board”. Therefore, an advantage is that the users can quickly switch to another “bulletin board” at a moment's notice. This makes the system essentially portable. With the present invention, the whole XML document will preferably be returned to the user. (This is different from standard XPath behavior where only the subset of the document that matches the search is returned). Before the document is returned, it can be scanned for executable logic, embedded in the document in the form of smart nodes. Smart nodes are XML nodes containing their own information and logic that can be executed without any other input. Thus, smart nodes may be executed before the document is returned.

Using the present system, a developer can create an application, defining the application in its own private XML schema, divulging only the information they deem pertinent, and in a format the developer deems appropriate. The same application running on a second client can then search, retrieve and interpret the XML and present it to the second user. The message will not be removed from the server immediately after a client has posted it there. The length of time it will remain on the server may be negotiated between the poster and the server. For example, the server administrator may wish to enforce a maximum retention period.

A helpful analogy in understanding the present invention is a physical bulletin board where notes may be posted and read. With a standard physical bulletin board, paper notes may be of different colors depending on topic (to aid searching). Knowing the color of a topic would make it easier to quickly glance over a board to locate notes of interest without having to read every single one. A community of users may have one particular shade of color set aside for their own exclusive use. Notes may also be of different sizes depending on posters. Some posters may have particular requirements, perhaps to include pictures, and so may be permitted to post larger notes. The administrator of the bulleting board may choose to check the notes for appropriate content, and remove those that violate policy. In the present computerized system, the poster of notes may instead include logic that is executed by the bulleting board as the XML document (i.e.: “note”) is accessed. Logic may be activated both when placing a note on the board, and when reading a note from the board. With this logic the poster can invoke functionality when placing the note. For example, if the note contains a question, and the answer is somewhere else on the board, then the present system can retrieve it. Or the logic may require the reader to successfully complete certain operations before gaining access to the message in the note. As such, the present system is essentially portable as different bulletin board locations can be set up per the users' own desires.

Another advantage of the present invention is the fact that there is no need for users to be known to one another or the server. Yet another advantage is that the application exists where the client decides that it should exist. If many clients agree to use the same location for posting messages and searching for each others messages, a multi-user application has then been created.

Another advantage of the present invention is that multiple applications can share a single server. Moreover, server side execution instructions can be included in the client-to-client messages. This allows the message sender to conditionally pass information to the recipient. A further advantage of the present invention is that different applications may use the same central message database in their own way, without constraining one another. One application may used one XML schema for its data, another application another schema.

In one aspect, the present invention provides a method of client to client communication, by: (a) providing a network comprising a first client, a second client and a server, wherein the same application is resident in each of the first and second clients, and wherein the application defines structure and content for an XML schema; (b) the first client running the application resident therein, thereby sending XML data to the server, wherein the XML data corresponds to the defined XML schema; (c) the second client running the application resident therein, thereby sending an XML search to the server, wherein the XML search corresponds to the defined XML schema; and (d) the server sending XML search results to the second client, wherein the XML search results comprise the XML data sent to the server by the first client.

### BRIEF DESCRIPTION OF THE DRAWINGS

FIG. 1 is an illustration of two clients communicating through a server (with one client posting data and one client searching the data).

FIG. 2 is an illustration of four clients communicating through a server (with three clients posting data and one client searching the data).

FIG. 3 is an illustration of multiple applications sharing a single server.

FIG. 4A is an illustration of seven clients communicating through a server (using three different applications), showing minimal logical separation.

FIG. 4B is an illustration of six clients communicating through a server (using two different applications), showing increased logical separation.

FIG. 4C is an illustration of six clients communicating through a server (using two different applications), showing assured logical separation.

FIG. 4D is an illustration of six clients communicating through two servers (using two different applications), showing physical server separation.

FIG. 5A is a first illustration of prior art client-server-database systems.

FIG. 5B is an illustration of the present invention's client-server-database system.

FIG. 6 is an illustration of where an application “resides” as between two clients.

FIG. 7A is a second illustration of prior art client-server-database systems.

FIG. 7B is a second illustration of the present invention's client-server-database system.

FIG. 8 is an illustration of client-to-client communication with a data repository in accordance with the present invention.

FIG. 9 is an illustration of “hub-less” client-to-client communication in accordance with the present invention.

FIGS. 10A and 10B are illustrations of data availability in accordance with the present invention.

FIG. 11 is an illustration of thin client and thick client shared cache and execution space in accordance with the present invention.

FIG. 12 is an illustration of a thick client populating a cache and a thin client then using the cache.

### DETAILED DESCRIPTION OF THE DRAWINGS

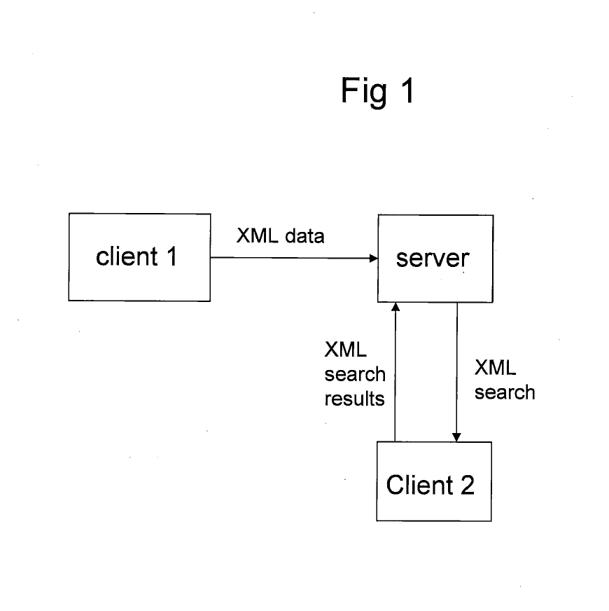

Referring first to FIG. 1, the present invention provides a method of client to client communication between Client 1 and Client 2, as follows. Both Client 1 and Client 2 are running the same application. (i.e.: the same application is resident on both Client 1 and Client 2). This application defines structure and content for an XML schema. In other words, the application itself defines both the information to send and how to interpret it. Thus, Client 1 and Client 2 are essentially free to define their own communication language. Importantly as well, with the present system the application is tied to the client. This is different from prior art systems in which the application is instead tied to (i.e.: runs on) a remote server.

In accordance with the present invention, the Client 1 sends XML data to the Server. (This XML data corresponds to the defined XML schema). Next, the Client 2 sends an XML search to the Server. (This XML search also corresponds to the defined XML schema). Finally, the Server sends XML search results back to Client 2. Preferably, these XML search results comprise the full XML data document sent to the Server by Client 1. Simply put, Client 1 sends data to the Server in a pre-arranged format/schema. Client 2 then launches an XML search (for example using XPath or XQuery) which expects to find information in this format.

For example, the application can be a Tennis Game Invitation application. Client 1 sends a message advertising his upcoming court time and is inviting someone to join him, as follows:

```
<tennisgame_invitation>
  <court>1</court>
  <day>Sunday></day>
  <time>2</time>
  <skill_level>medium</skill_level>
<tennisgame_invitation>
```

Client 2 is looking to play tennis on court 1 during the weekend. He is not particular about either time or skill level. Therefore, he does a search for possible games with an XPath statement, as follows:

/tennisgame_invitation/[court=“1” and (day=“Saturday” or day=“Sunday”)]
This search will get a hit on the XML document sent up from Client 1.

As can be seen, the whole XML document send by Client 1 is returned to Client User 2. Importantly, this is different from the standard XPath behavior, where only a subset of the document (i.e.: only the part that matches the search), are returned.

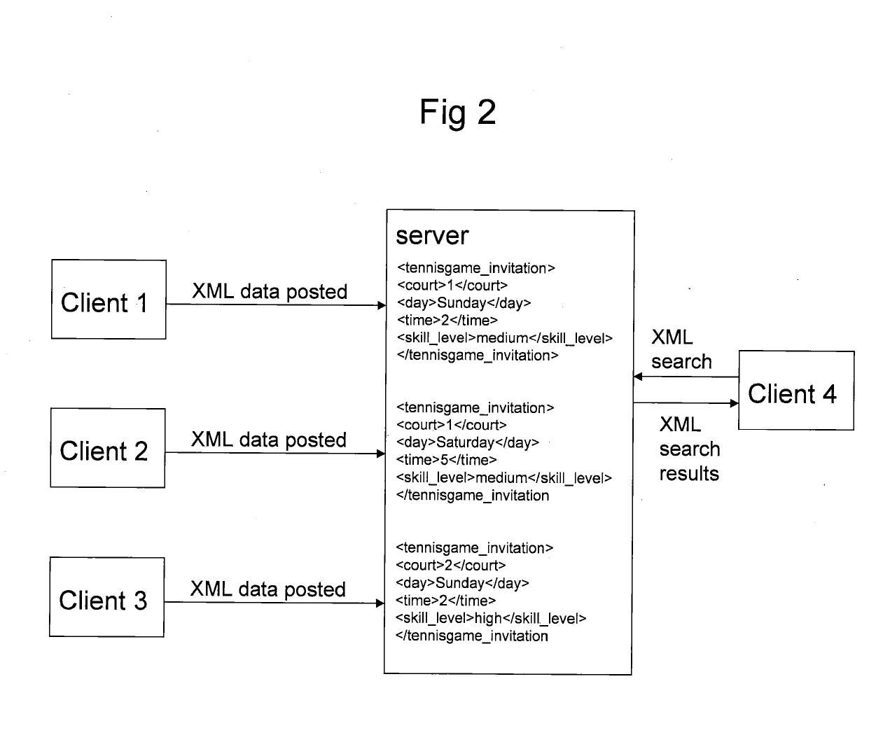

Referring next to FIG. 2, a system of communication is shown where a plurality of different clients (i.e.: Client 1, Client 2 and Client 3) all send XML data to the same Server. Client 4 then sends an XML search to the Server, and the Server sends XML search results back to Client 4. In this illustration, Clients 1, 2, 3 and 4 all run the same application (and the application is resident on the Clients). The Server is merely the mutual contact point.

As can be seen, there is no need for Clients 1, 2, 3 and 4 to be known in advance either to one another or to the Server. Instead, as with the bulleting board analogy, any Client could post or read. Moreover any one Client may use the present system to selectively pass messages to any other Client. A further key difference from existing systems (such as Jabber) is in the ability to include server side execution instructions in the client-to-server-to-client messages; which among other things allows the message sender to conditionally pass information to the recipient Client.

As can also be seen, the application itself actually has a distributed existence. It exists where the Clients decide that it should exist. If many Clients agree to use the same location, a multi-user application has thereby been created. Clients may use the present system for client-to-client communication if they so choose, as can easily be done with a bulletin board too. The options for privacy and anonymity that a bulletin board affords (e.g.: structuring or encoding the posts) are likewise available with the present system. Moreover, the ability to add logic to the XML data posts (from Clients 1, 2 and 3) can optionally be used to create additional desired functionality (such as access control).

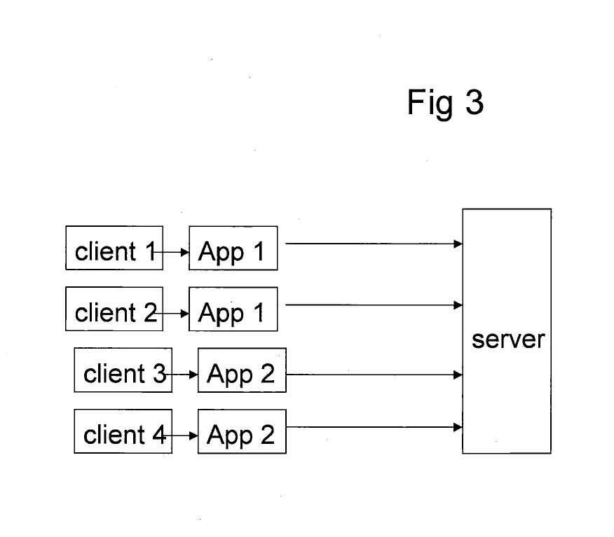

FIG. 3 illustrates the case of multiple Clients 1, 2, 3, and 4 running different applications on the same Server. Specifically, Clients 1 and 2 both run Application 1 on the Server. Simultaneously, Clients 3 and 4 both run Application 2 on the Server. Thus, different applications can be simultaneously run on the same Server. As far as each of the Clients 1, 2, 3 and 4 are concerned, they are simply interacting with a bulletin board. The Server only acts as a neutral platform intermediary (i.e.: it need not care about the operations it executes or the content it transmits).

When different Applications share the same Server, the possibility of “cross talk” always exists. What “cross talk” means in this context is the possibility of one application getting message meant for another.

For example, Application 1 posts messages (e.g.: from Client 1 or 2 to the Server) in the following format:

```
<element1>
  <element2>
    <game>tennis</game>
    <court>2</court>
    <day>Saturday</day>
  </element2>
</element1>
```

and searches for messages with this URL:
http://domain/element1/element2,
with the XPath statement “/element1/element2”

However, Application 2 posts messages (e.g.: from Clients 3 or 4 to the Server) in the following format:

```
<element1>
  <element2>
    <game sport=”tennis”/>
    <location type=”court”>2</location>
    <time day=”Saturday”/>
  </element2>
</element1>
```

and search for messages with this URL:
http://domain/element1/element2,
with the XPath statement “/element1/element2/

As can be seen, the information in the two posts (i.e.: one from Application 1 and one from Application 2) are largely identical but formatted differently, they follow different XML schema, and therefore can not be mutually recognized. However, the XPath searches for both applications are identical and will therefore return both documents. One of the messages will be interpreted correctly, as the message follows the XML schema the application expects, the other will not.

One common way to solve the problem of cross talk has been to host the messages on different servers. For example, Application 1 can search for messages on a one server using:

http://domain1/element1/element2

Whereas Application 2 can search for messages on another server using:

http://domain2/element1/element2

This above approach is how such conflicts are usually handled on current application server technology (i.e.: with the separate Applications having their own domain names and servers). In effect the domain name is (application) specific, and the XPath is short and generic.

Another way to solve the same problem would be the reverse; to have the search statement for the messages be less generic. For example, Application 1 can search for messages using:

http://domain/element1/element2/game[text( )=“tennis”]

Whereas Application 2 can search for messages using:

http://domain/element1/element2/game[sport=“tennis”]

In effect the domain name is generic (multiple applications share a domain name), and the XPath is application specific. However, there is still the risk that different Applications may search on each others messages.

The present invention, however, includes a third novel approach with namespaces being used in the XML (and XPaths), as follows:

The original example can be restated with Application 1 posts messages (e.g.: from Client 1 or 2 to the Server) in this format:

```
<app1:element1>
  <app1:element2>
    <game>tennis</game>
    <court>2</court>
    <day>Saturday</day>
  </app1:element2>
<app1:element1>
```

and search for messages with this URL:
http://domain/app1:element1/app1:element2

However, Application 2 posts messages (e.g.: from Clients 3 or 4 to the Server) in this format:

```
<app2:element1>
  <app2:element2>
    <game sport=”tennis”/>
    <location type=”court”>2</location>
    <time day=”Saturday”/>
  </app2:element2>
</app2:element1>
```

and search for messages with this URL:
http://domain/app2:element1/app2:element2

Using this approach, there is now assured separation of application data. The use of namespaces also lends itself well to security implementations (for example, where namespaces can be tied to specific users or apps).

In yet another aspect of the present invention, the XML data can be sent from Clients to Server as an XPath statement in a URL. This approach is beneficial since a Client can not be expected to type in a complex XML document and use CURL (or some similar utility) to send this XML document to the Server. Specifically, the present invention comprises another way that works along lines that users are already familiar with and is compatible with existing procedures and tools, being the URL.

A URL typically falls into four parts, being (1) the Protocol; (2) the Server (domain name); (3) the Application Path; and finally (4) the Input to the application, if any.

An example would be something like this:
http://www.domain.uk/news?events=current&location=Egypt
Where “http://” is the protocol; “www.domain.uk” is the server; and “/news” is the application path. An addition parameter can be passed to the application by tacking on an ampersand separated list of attribute-value pairs after a question mark. In this example: ?events=current&location=Egypt

The standard URL application path is replaced with an XPath statement. In its most simple form, an XPath statement looks exactly like a regular path and an Application Designer can offer the user something that looks very much like what they are used to. An advantage of this is that, in some cases, they can use their existing browser bookmarks without noticing any difference. But the capabilities have been expanded and more sophisticated users and applications will be able to do much more. For example, consider a database that has a multitude of XML documents, as follows:

### XML Document 1

```
<news>
  <international>
  <Africa>
    <Egypt>
    </Egypt>
  </Africa>
  <Europe>
    <France>
    </France>
  </Europe>
</international>
</news>
```

### XML Document 2

```
<news>
  <national>
    <political>
    </political>
  </national>
</news>
```

### XML Document 3

```
<news>
  <economic>
    <country=”Egypt”>
    </country>
  </economic>
</news>
```

### XML Document 4

```
<news>
  <sports>
    <football team=”Liverpool”>
    </football>
    <hockey team=”Liverpool”>
    </hockey>
  </sports>
</news>
```

### XML Document 5

```
<gossip>
  <celebrities>
    <sportsstarts team=”Liverpool”>
    </sportsstarts>
  </celebrities>
</gossip>
```

On this database the following URLs, with XPaths, are run

| | Document nr. |
|---|---|
| URL | returned |
| http://domain/news//[@country=Egypt] | 3 |
| http://domain/news/international/Europe | 1 |
| http://domain/gossip/celebrities | 5 |
| http://domain/news/sports/football[@team=”Liverpool] | 4 |
| http://domain//*[@team=”Liverpool] | 4 |

All these searches dip into the database and return matching documents. The XML documents in the sample above follow no consistent structure. This is by intention. Element names and attribute names were mixed to illustrate that multiple XML schemas can commingle. This is essential if multiple application are to share the server. The server must be quite generic and handle any XML. It is the applications that are specific and have specific requirements in how the data they put out or consume is formatted. In accordance with the present invention, the whole XML document is returned by the search even when only a small part of the document matches the XPath search terms. XML Smart Nodes may be embedded in the XML document, containing additional logic, and all such nodes are executed before the document is returned to the requestor. The logic may contain additional instructions including instructions to rewrite the document. The rewriting may amount to denying access the document unless the requests meets defined requirement. This logic permits the sender of the document to implement desired access control.

In yet another aspect of the invention, namespaces can be used to ensure that XML search results from different applications are not incorrectly mixed together. For example, assume a Application 1 uses XML searches in the following format:

```
<news>
  <country>
    <data/>
  </country>
</news>
```

Application 2 run its searches like this “/news//data” and all it's entries follow this second format:

<news>
<data/>
</news>

As can be seen, Application 2 will receive XML search results from Application 1 as well as it's own. This can easily be prevented with the use of namespaces, as follows:

Restating the example above, search Application 1 with /app1:news/app1:country/app1:data

```
<app1:news>
  <app1:country>
    <app1:data/>
  </app1:country>
<app1:/news>
```

And search Application 2 with: /app2:news//app2:data

<app2:news>
<app2:data/>
</app2:news>

The two XML searches are now cleanly separated and Applications 1 and 2 do not interfere with, or have access to, each others data in any way. Application separation can in this way be assured even though they share the same server infrastructure. Moreover, access control can easily be enforced on a namespace basis. For example, a Client may only add/modify/search data in a given namespace.

In accordance with the present invention, an XML search can match on any part of an XML document posted to the server. Importantly, however, the XML search results can return all the posted XML documents that have a match, not just the matching part of those XML documents. This is a departure from the way XPath searches normally work, in which only the matching nodes of the XML documents are returned.

Using namespaces in the XML and XPath security can restrict access to the posted XML documents, but more fine grained document access can be achieved with smart documents (i.e.: where smart nodes are embedded in the documents). Specifically, the poster of a document can embed smart nodes in it to create such processing as restricts document access and presentation in any desired way. Using this approach, all XML documents returned from the XPath search are passed through a smart node processing step.

Moreover, using Smart Nodes embedded in the XML document, Client posting the XML document may introduce logic to be executed on the Server before the message is passed along to another client as XML search results. In this logic, the Client posting the XML document may place restrictions on the requestor such that depending on the information submitted by the requestor the message is transformed. For example, the poster may whish to make the message only available to one specific requestor; one who perhaps is authenticated and has a specific username, or possesses a secret shared by the poster and the requestor. Specifically, in the tennis game invitational examples shown above, the poster can include logic to only make the invitation available to requestors who submit information about their game skills and this being above a certain level.

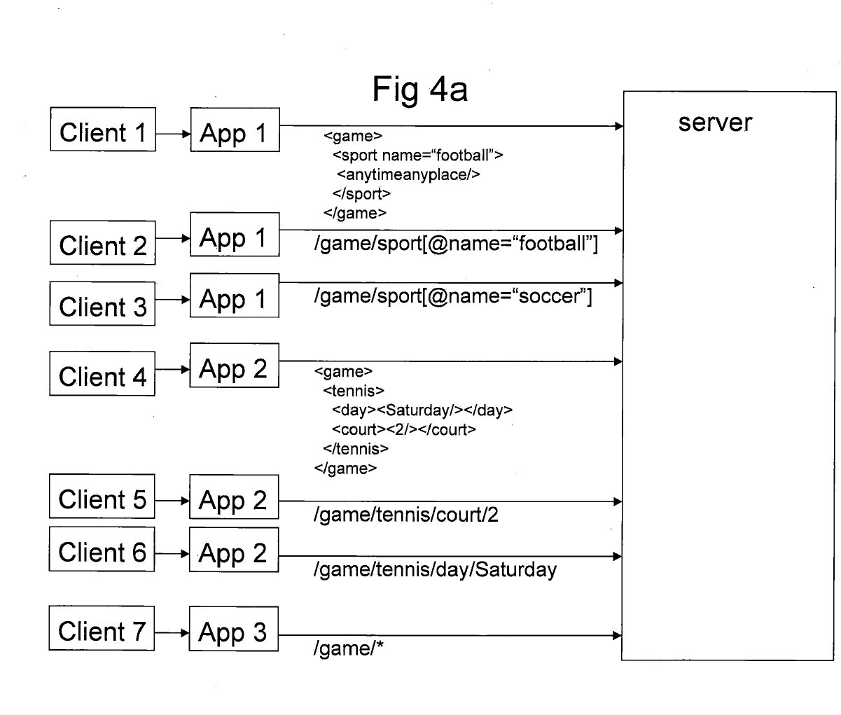

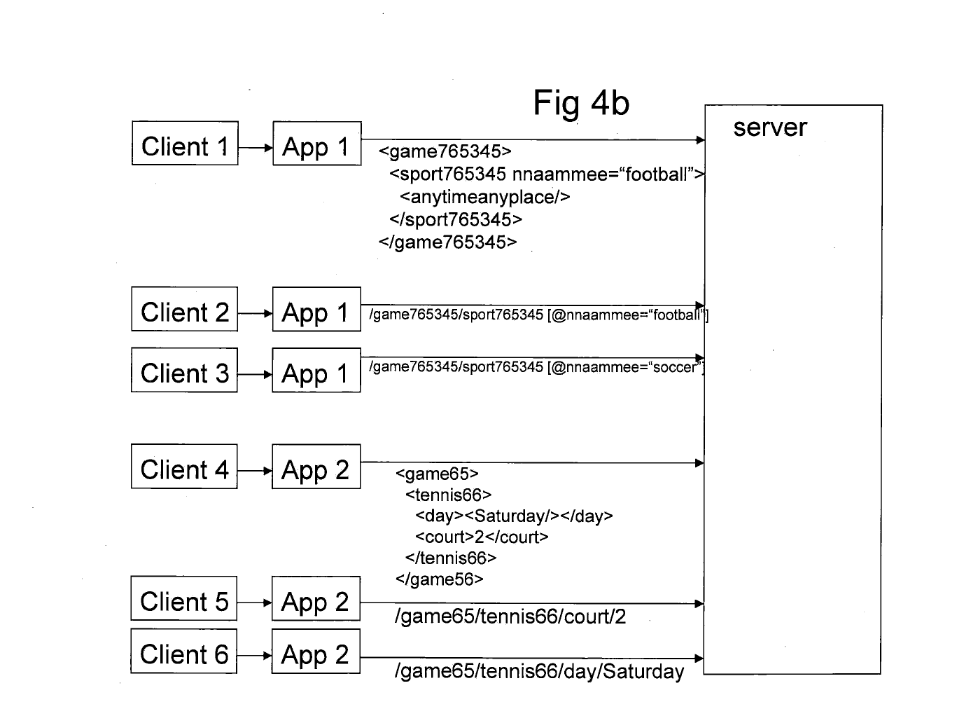

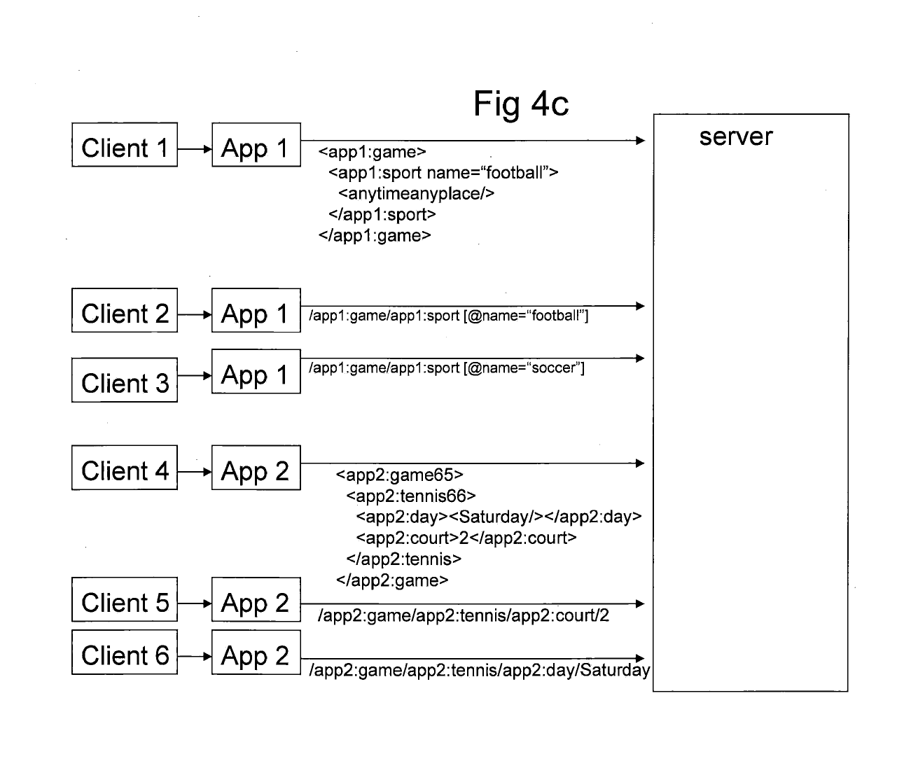

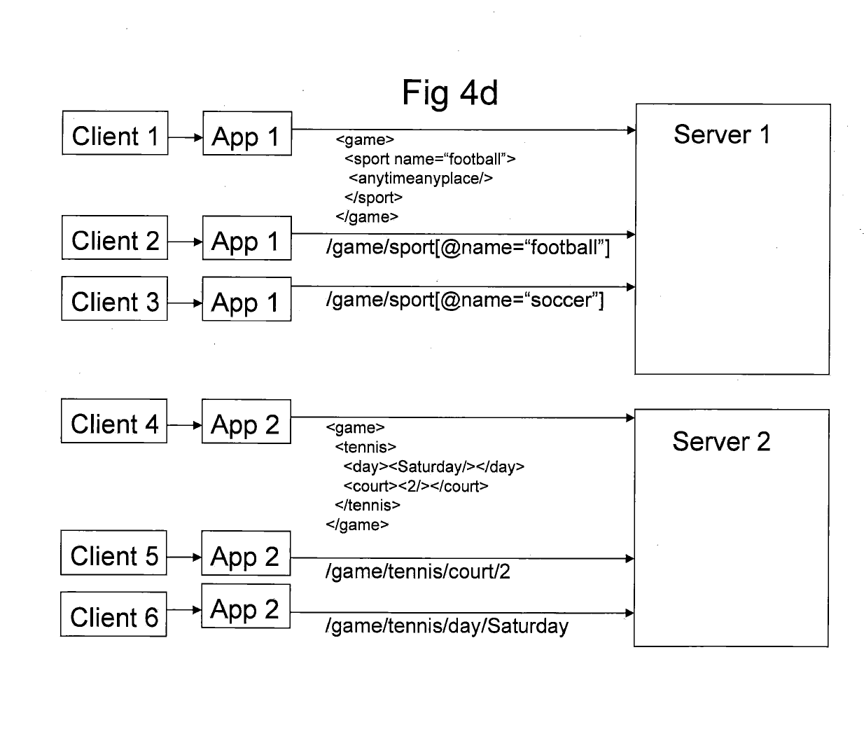

FIG. 4A illustrates seven clients communicating through a server (using three different applications), showing minimal logical separation. The XML document postings made by each of the seven Clients are also illustrated. Specifically, Clients 1, 2 and 3 all use Application 1; Clients 4, 5 and 6 all use application 2; and Client 3 uses Application 3. As can be seen, all three of these Applications share the same Server. Clients 1 and 4 are posting XML documents to the Server. Clients 2, 3, 5, 6, and 7 are posting XPath search requests to the Server. As can be seen, Client 2 will get a match to the to Client 1's posting; whereas Client 3 will not get a match to Client 1's posting. This is because Client 2's XPath search statement conforms to the structure and data of Client 1's XML document, whereas Client 3's XPath search statement does not. Similarly, Clients 5 and 6 will both only get a match to the postings of Client 4. Lastly, Client 7 is using a much more generic Application 3. As a result, Client 7 will get a match to the postings of both Clients 1 and 4.

FIG. 4B illustrates six Clients communicating through a server (using two different applications), showing increased logical separation. Specifically, Clients 1, 2 and 3 all use Application 1 which posts XML documents about a specific game “game765345”. Thus, only Clients 2 and 3 (who are searching for “game765345”) will receive a hit. Similarly, Client 4 uses Application 2 to post XML documents about a specific game “game65 tennis66”. Thus, only Clients 5 and 6 (who are searching for “game65/tennis66”) will receive a hit. As can be appreciated, the likelihood of cross-talk is substantially reduced (especially when using very eccentric element and attribute names). For many application designers, this will be quite sufficient since the designer will have complete freedom to choose the XML in the postings and the XPath used to search the posts. Moreover, even if crosstalk occurs, it isn't likely to be significantly harmful. For example, an overly general search will most likely not be able to make any sense of the message it receives since the message structure will be different.

FIG. 4C illustrates six clients communicating through a server (using two different applications), showing assured logical separation. In this configuration, namespaces are used to entirely preclude the possibility of cross-talk. This can be coupled with a security mechanism to ensure that the appropriate application or user is actually making the posts and search requests in the namespace.

FIG. 4D illustrates six clients communicating on two different servers, showing physical server separation. Specifically, Clients 1, 2 and 3 communicate through Server 1, whereas Clients 4, 5 and 6 communicate through Server 2. This multi-server approach is how things are usually done with today's technology. Every Application has its own Server (and server application). There is no danger of cross-talk. However, the use of multiple servers inevitably drives up costs and decreases server utilization.

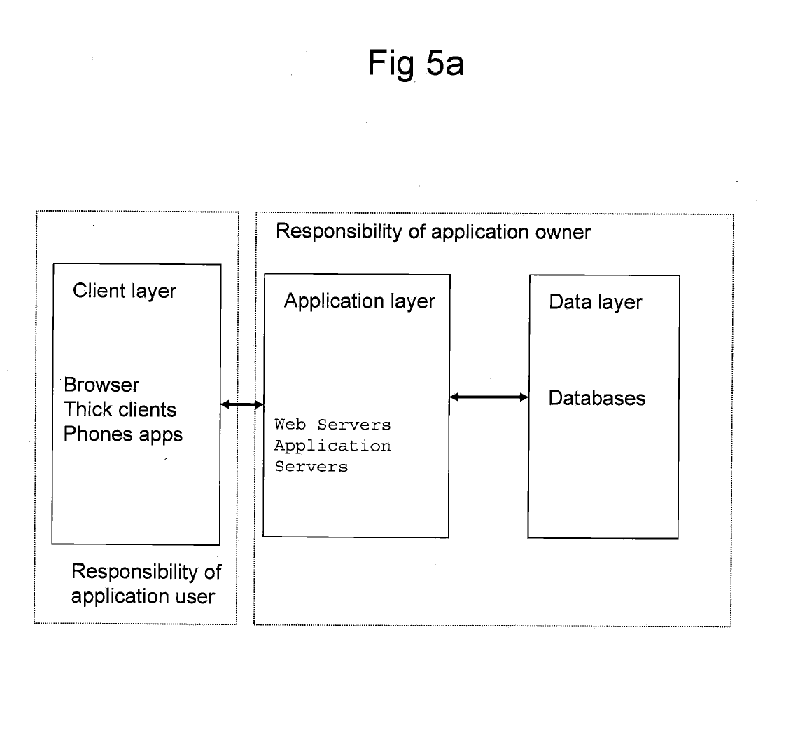

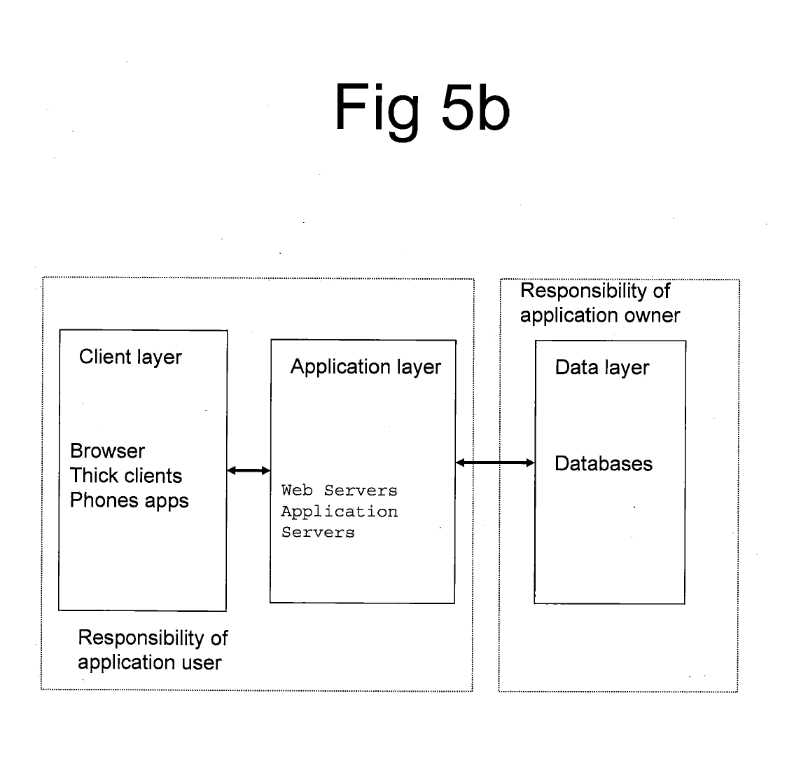

FIG. 5A illustrates a typical existing client-server-database system. Specifically, only the client layer (e.g.: browser or phone app) is the responsibility of the Application user. The owner of the Application is responsible for hosting the Application in a manner that makes it available to the user.

In contrast, FIG. 5B illustrates the present invention in which both the client layer (e.g.: browser or phone app) and the application layer (e.g.: web server or application server) is the responsibility of the Application user. Advantageously, the application is available where the users choose to make it available. The users are therefore responsible for choosing a platform that has the desired performance characteristics. The user can optionally choose to run the Application slowly and have only limited availability in order to save money. If the users does not need 100% availability, they can make large savings.

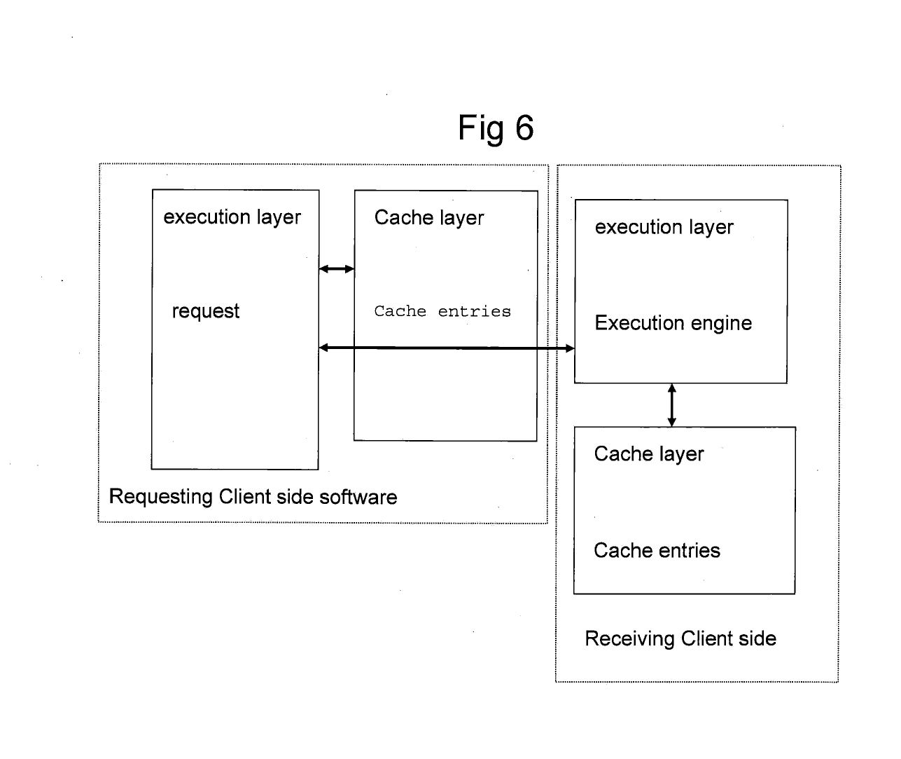

FIG. 6 is an illustration of where an application “resides” as between two clients. As can be seen, the application is basically “shared” between the clients since the requesting and receiving clients have their own execution and cache layers.

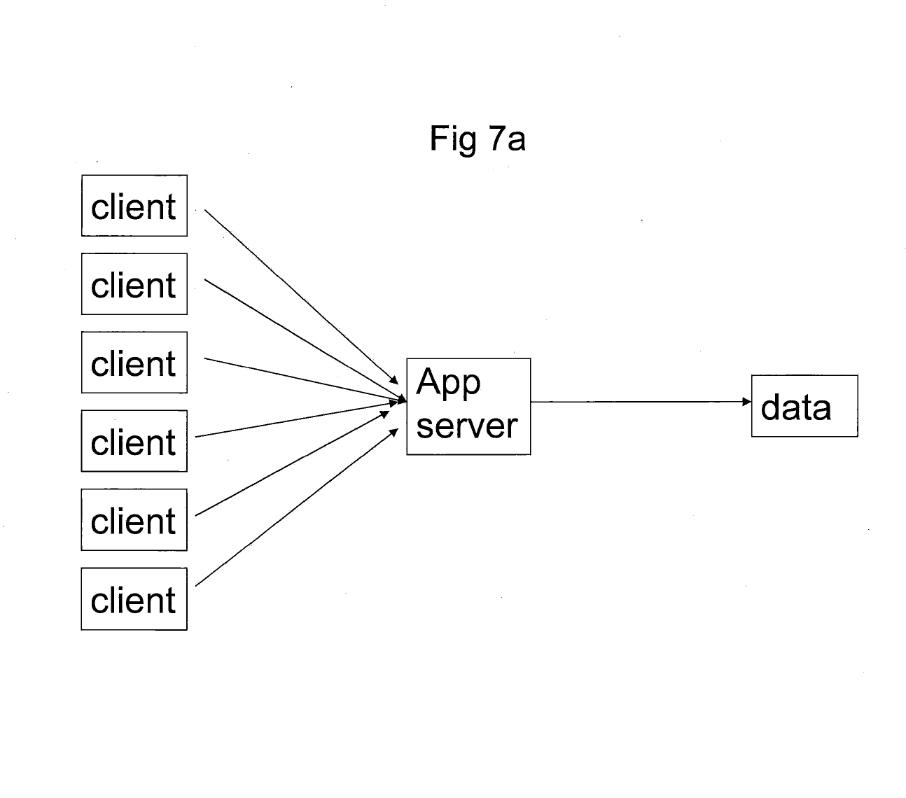

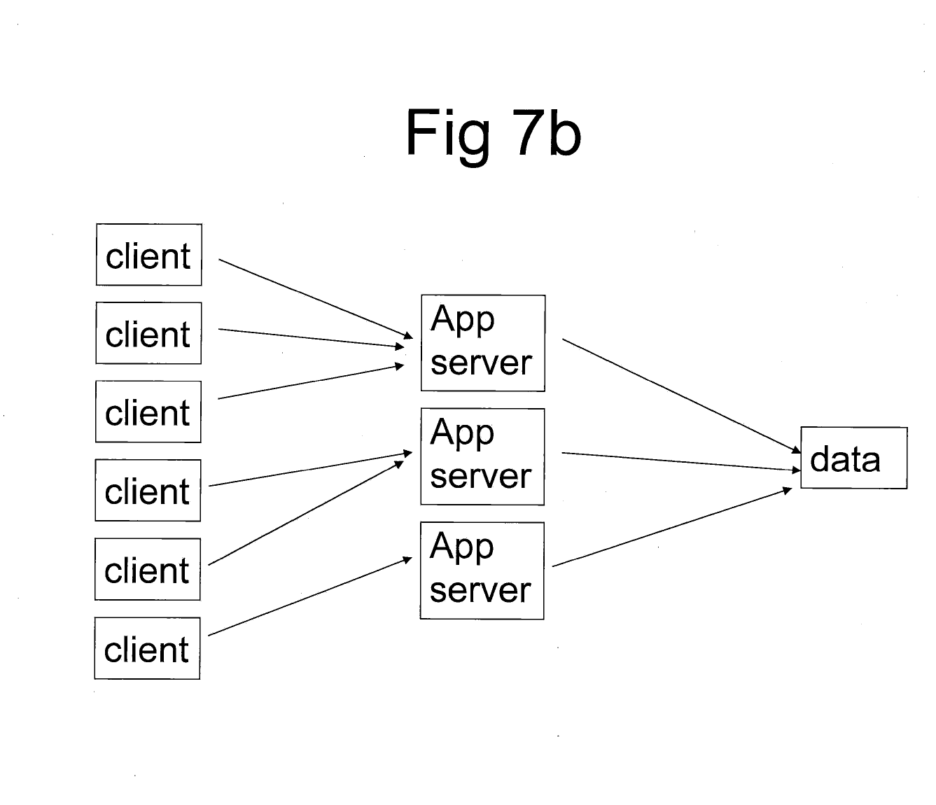

FIG. 7A illustrates a typical existing client-server-database system in which many Clients direct traffic to a defined pre-chosen Server. This server can be designated by the use of one particular domain name. In this arrangement, application server traffic to the database can be easily controlled. This is because the network administrators know precisely from what sources the data can be accessed.

In contrast, FIG. 7B illustrates the present invention in which Clients are free to direct traffic to the Server of their choice. There is no need for the server to be the same server for all users of the same application. As can be seen, the various application servers can each access the data, but this access now comes from many different sources. As such, the network administrator may not know precisely which clients are accessing the database.

It is to be understood that the present invention provides both a method and a physical system. Specifically, the present invention provides a computer network, comprising: (i) a first client having an application resident thereon wherein the application defines structure and content for an XML schema; (ii) a second client also having the application resident thereon; and a (iii) server, wherein the first client sends XML data to the server, the XML data corresponding to the defined XML schema, the second client sends an XML search to the server, the XML search corresponding to the defined XML schema, and the server sends XML search results to the second client, wherein the XML search results comprise the XML data sent to the server by the first client.

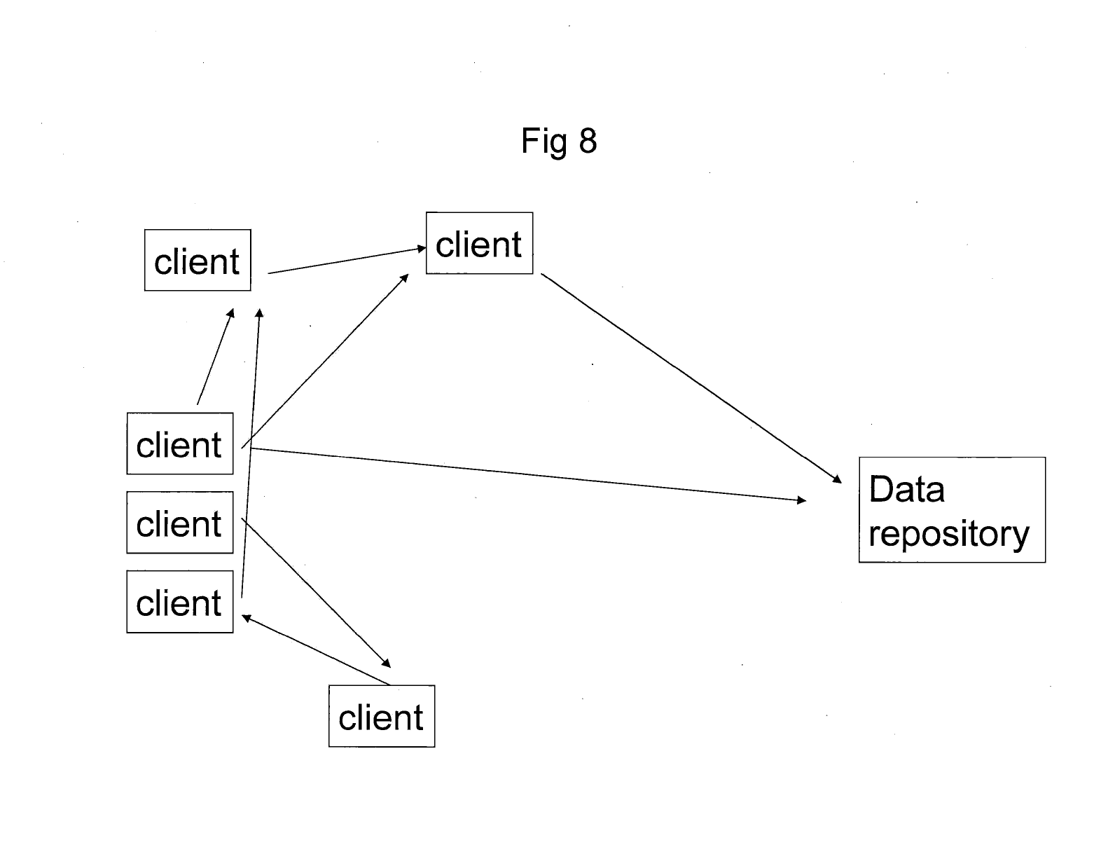

FIG. 8 is an illustration of client-to-client communication with a data repository in accordance with the present invention. As can be seen, various clients may communicate directly with one another, or with a data repository. Clients simply direct traffic to other clients of their choice. This functionality is achieved because the client software both handles and sends requests, thereby functioning both as a client and as a server. Moreover, although data can be centrally hosted, load can be substantially reduced by caching on various clients (and clients can read from the cache kept on other clients before having to read from the data repository).

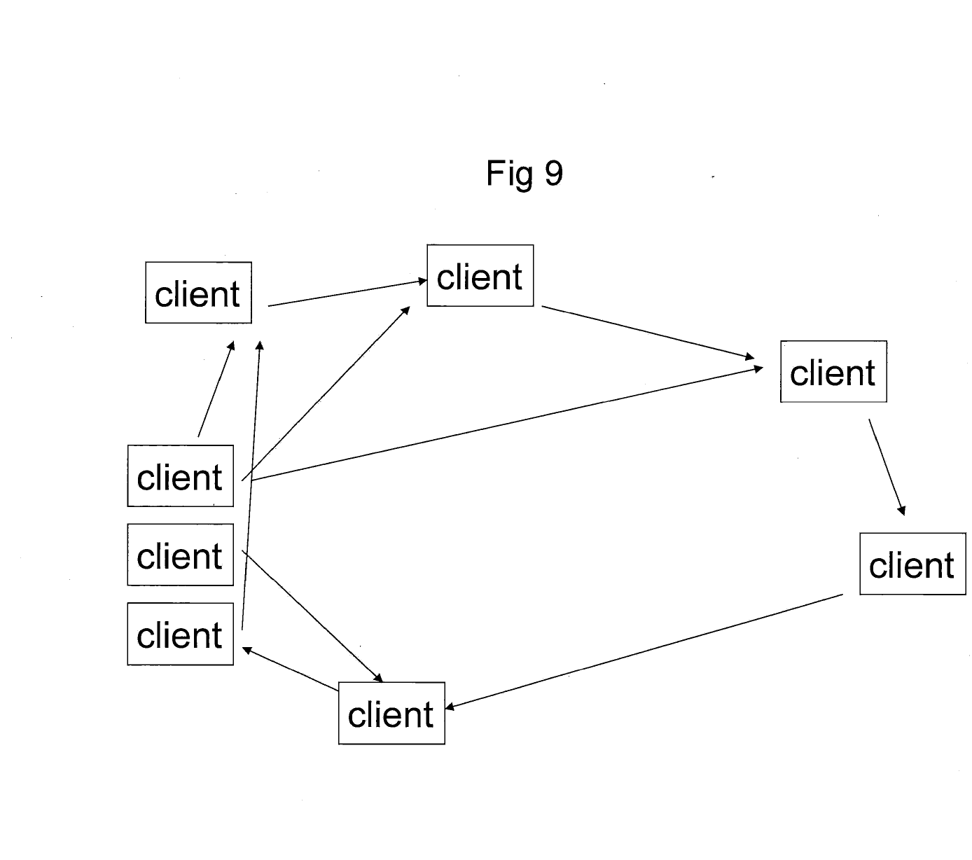

FIG. 9 is an illustration of “hub-less” client-to-client communication in accordance with the present invention. FIG. 9 is similar to FIG. 8, but the data repository has been removed. In this arrangement, data is spread out among the clients as it is requested. Both requests and responses are cached, and clients can search each other's requests and cached responses to those requests. Thus, data originating from a first client can be accessed though a second client even when the first client is off line.

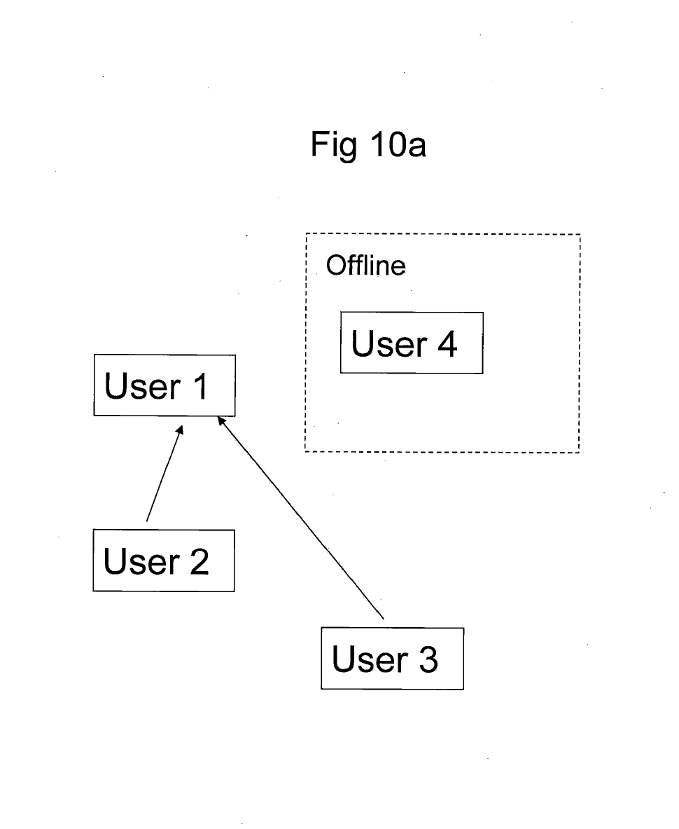

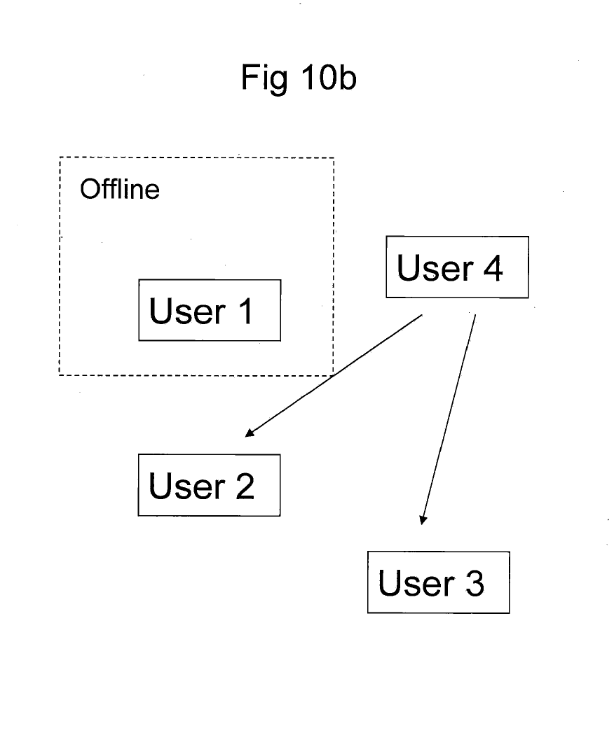

FIGS. 10A and 10B are illustrations of data availability in accordance with the present invention. In FIG. 10A, Clients 2 and 3 have accessed (and cached) data kept at Client 1. Client 4 is offline. Next, in FIG. 10B, Client 1 goes offline and Client 4 comes online. At this time, Client 4 can access the data Client 1 has by requesting to access the cached requests of either of Clients 2 or 3. As both have made the request for the data of Client 1, a search against their requests will return the data.

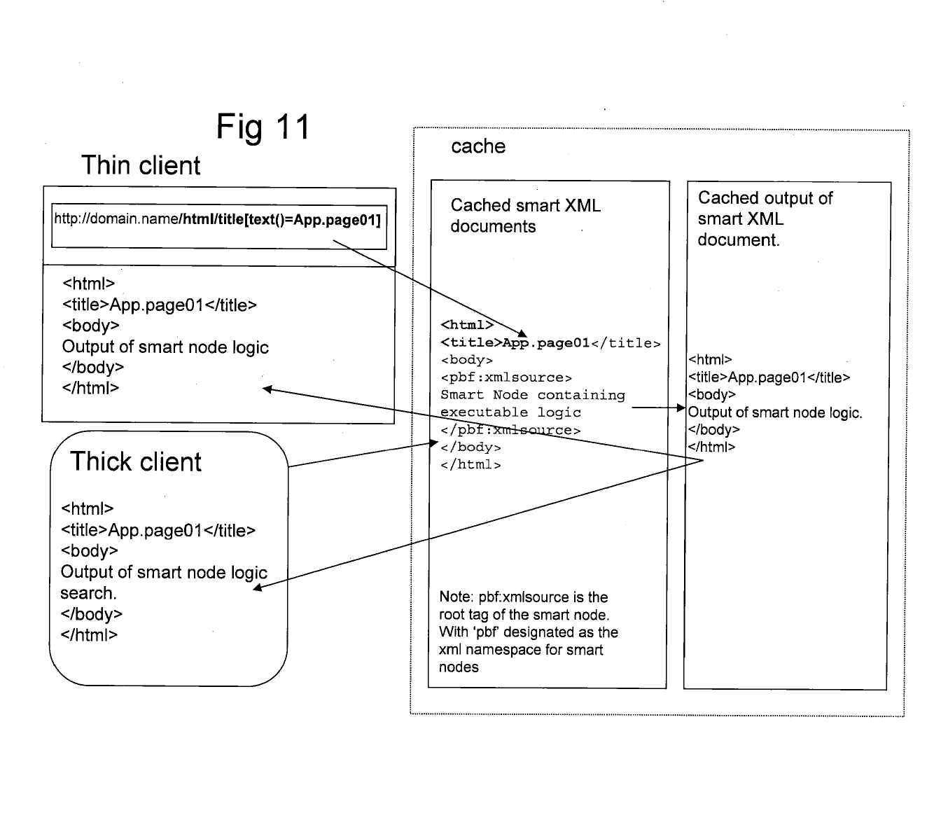

FIG. 11 is an illustration of thin client and thick client shared cache and execution space in accordance with the present invention. In this example, an XML document containing smart nodes has been placed into the cache by the thick client. The output of this smart XML document is also cached. The thin client can then access this cached smart XML document by entering an XPath search directly from the browser bar. Once this is done, the entire XML document will be retrieved from the cache and the smart nodes inside it executed, before the resulting document is returned to the requestor.

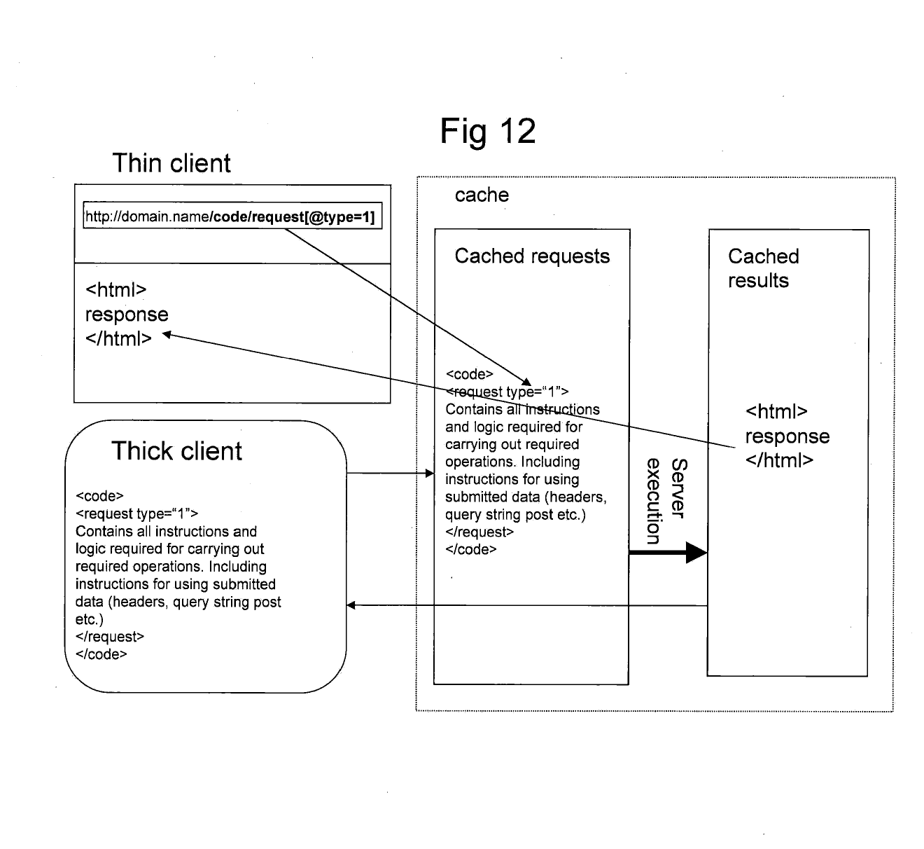

FIG. 12 is an illustration of a thick client populating a cache and a thin client then using the cache. In this example, the thick client sends a request to the cache that contains everything the receiver needs to carry it out (e.g.: input data, logic, etc.). The server then executes the request and stores the response in the cache. Next, the thin client can then enter an XPath search directly from the browser bar. This search will invoke logic that is kept in the cached requests (rather than sending its own logic). By using standard URLs, the thin client appears as a web application. Advantageously, however, no application has been installed or is permanently in place at the server. Nevertheless, the thin client URL really produces data (and the data can be submitted by the browser in the form of headers, query strings or post data). The logic invoked by the XPath can act on this data, in the form of smart nodes embedded in the xml document. The result (as viewed by a user operating the browser) is that they are operating a real server application. A further advantage is that, even if the cache is completely empty, any client capable of submitting smart node containing XML documents may use the server. As the cache becomes populated, the server can also be used by clients invoking simple URLs without any XML.

It is to be understood that the “server” as described herein (and as recited in the claims below) may possibly be a separate physical device from the clients (such as a traditional server with many client browsers accessing the server). In addition, however, the “server” as described herein (and as recited in the claims below) can instead be located on the same physical device as the client. For example, both client and server can be located on the same smart phone, or hand held device. In this second embodiment, the recipient of a request is effectively the “server” for the purposes of answering that request. When it in turn sends a request somewhere else, it is acting as the client. Thus, “client” and “sever” can optionally be different bits of actual code doing different things, but resident on the same physical device. In this situation, one client sending a smart request to another in effect results in a server-type of functionality in a place where a server didn't exist before. Specifically, once the request has been made, its request data (and any logic contained in it) may reside in the recipient's cache for some one else to call upon and use. This would result in a multi-user application in a place where none existed before.

What is claimed is:

1. A method of client to client communication, comprising:
providing a network comprising a first client, a second client and a server, wherein the same application is resident in each of the first and second clients, and wherein the application defines structure and content for an XML schema;
the first client running the application resident therein, thereby sending XML data to the server, wherein the XML data corresponds to the defined XML schema;
the second client running the application resident therein, thereby sending an XML search to the server, wherein the XML search corresponds to the defined XML schema; and
the server sending XML search results to the second client, wherein the XML search results comprise the XML data sent to the server by the first client.

2. The method of claim 1, further comprising:
a plurality of clients sending XML data to the server, wherein all the XML sent to the server corresponds to the defined XML schema.

3. The method of claim 2, wherein the XML search results sent from the server to the second client comprise all documents sent by the plurality of clients that contain a match to the XML schema.

4. The method of claim 2, further comprising:
a plurality of clients sending XML searches to the server, wherein all the XML data sent to the server corresponds to the defined XML schema.

5. The method of claim 4, wherein the XML search results sent from the server to the plurality of clients sending XML searches comprise all documents sent by the plurality of clients that contain a match to the XML schema.

6. The method of claim 1, wherein the entire XML data the first client sends to the server is sent to the second client.

7. The method of claim 4, wherein,
some of the plurality of clients sending XML data to the server have a first application resident therein,
some of the plurality of clients sending XML data to the server have a second application resident therein,
some of the plurality of clients sending XML searches to the server have the first application resident therein, and
some of the plurality of clients sending XML searches to the server have the second application resident therein, such that
a client sending XML searches using the first application receives XML data send by clients using the first application, and
a client sending XML searches using the second application receives XML data send by clients using the second application.

8. The method of claim 7, wherein both the first and second applications send XML data to the same server.

9. The method of claim 1, wherein the entire XML data sent by the first client to the server is sent from the server to the second client.

10. The method of claim 1, wherein the XML search is performed in XPath language or XQuery language.

11. The method of claim 1, wherein the XML data comprises instructions to the server.

12. The method of claim 1, wherein the XML data comprises executable logic embedded in a XML document.

13. The method of claim 1, wherein the XML data is sent as an XPath statement in a URL.

14. A computer network, comprising:
a first client having an application resident thereon wherein the application defines structure and content for an XML schema;
a second client also having the application resident thereon; and
a server, wherein
the first client sends XML data to the server, the XML data corresponding to the defined XML schema,
the second client sends an XML search to the server, the XML search corresponding to the defined XML schema, and
the server sends XML search results to the second client, wherein the XML search results comprise the XML data sent to the server by the first client.

15. The computer network of claim 14, further comprising:
a plurality of clients sending XML data to the server, wherein all the XML sent to the server corresponds to the defined XML schema; and
a plurality of clients sending XML searches to the server, wherein all the XML data sent to the server corresponds to the defined XML schema.

16. The computer network of claim 14, wherein the XML data comprises:
XML nodes that comprise logic that can be executed without additional input.
